(19) United States
(12) Patent Application Publication
(10) Pub. No.: US 2026/0243100 A1
(43) Pub. Date: Aug. 20, 2026

(54) Pool Cleaning Robot with Bypass Filtration Flow System

(71) Applicant: BETTABOT INC., Santa Fe Springs, CA (US)

(72) Inventors: Xinyue FAN, Irvine, CA (US); Yulu Luke CHEN, South Pasadena, CA (US)

(21) Appl. No.: 19/541,364

(22) Filed: Feb. 16, 2026

Related U.S. Application Data
(60) Provisional application No. 63/759,523, filed on Feb. 17, 2025.

(51) Int. Cl. E04H 4/16; B01D 29/15; E04H 4/12; C02F 103/42

(52) U.S. Cl. CPC E04H 4/1654; B01D 29/15; E04H 4/1245; E04H 4/16; E04H 4/1663; C02F 2103/42; C02F 2209/40

(57) ABSTRACT

A pool cleaning robot includes a main body, a water pump, a main filter assembly, and a bypass filtration flow system. The bypass filtration flow system includes a bypass filtering channel, a bypass filter, and a control valve. The control valve is provided in the receiving cavity to selectively operate between a second position and an first position, wherein in the second position, the control valve is moved to block the bypass filtering channel so that pool water flowing into the receiving cavity is forced to solely pass through the main filter assembly. In the first position, the control valve is moved to open the bypass filtering channel so that the pool water flowing into the receiving cavity is arranged to flow through at least one of the main filter assembly and the bypass filter.

### CROSS REFERENCES OF RELATED APPLICATION

This application is a non-provisional application of a provisional application having an application number of 63/759,523, and a filing date of February 17, 2025, the entire specification of which is herein incorporated by reference.

### BACKGROUND OF THE PRESENT INVENTION

### Field of Invention

The present invention relates to a pool cleaning robot, and more particularly to a pool cleaning robot comprising a bypass filtration flow system which is capable of substantially increasing filtration efficiency and increasing the general lifespan of a filter assembly.

### Description of Related Arts

A conventional pool cleaning robot uses motors to drive wheels or tracks to move along pool floors. The conventional pool cleaning robot comprises a main body having at least one water inlet and one water outlet, and a filtration assembly provided in the pool body, wherein water in the pool may enter the main body through the water inlet, arranged to pass through the filtration assembly, and finally exit the main body through the water outlet. The conventional pool cleaning robot may also comprise at least one water pump mounted in the main body to facilitate water circulation and debris removal performance of the filtration assembly.

The filtration assembly usually comprises a chamber with an inlet opening communicating with the water inlet, and a filter screen mounted in the chamber. When the water pump operates, water enters the filtration assembly through the inlet opening, passes through the filter screen, and is then discharged back to the pool through the water outlet. As water flows through the filtration assembly, debris and particulates are trapped by the filter screen, preventing them from re-entering the pool.

When the water pump of the pool cleaning robot operates, water is drawn into the filtration assembly through the water inlet and subsequently discharged through the water outlet, forming a flow path. As water passes through the filtration assembly, debris and particulates are captured by the filter screen and continuously accumulate on it, eventually causing a blockage in the flow path. However, the pool cleaning robot relies on sufficient water entering the flow path to carry debris and particulates into the filtration assembly, while also expelling enough water to assist the robot in operating on the pool floor or climbing walls. A blocked flow path not only reduces the cleaning efficiency of the pool cleaning robot but also affects its ability to operate and climb walls.

Currently, several patents related to the bypass mechanism of pool cleaning robot primarily aim to address operational and wall-climbing issues caused by flow path blockages. For example, the bypass flow channels in US10,378,229 and US2022/0112735A1 do not pass through the filtration assembly. While opening a bypass valve helps maintain the water discharge rate of the pump, debris drawn into the bypass flow channel are still expelled into the pool along with the water flowing therethrough. On the other hand, the bypass methods dissecond in Chinese patents CN117323733A, CN116696132B, and CN221524389U direct water through the filtration assembly. However, they are still unable to ensure that the bypass water flow sufficiently passes through each filtration mesh area, preventing the pool cleaning robot from achieving optimal filtration performance.

As a result, there is a need to improve upon the conventional pool cleaning robots described above so as to substantially increase filtration efficiency and the general lifespan of a filter screen.

### Summary of the Present Invention

Certain variations of the present invention provide a pool cleaning robot comprising a bypass filtration flow system which is capable of substantially increasing filtration efficiency and increasing the general lifespan of a filter assembly.

Certain variations of the present invention provide a pool cleaning robot comprising a bypass filtration flow system, wherein the bypass filtration system is capable of allowing water to flow through at least one bypass filtering channel when a main filter assembly of the pool cleaning robot is substantially blocked by pool debris.

Certain variations of the present invention provide a pool cleaning robot, comprising:

a main body having a receiving cavity, a water inlet, and a water outlet, the water inlet and the water outlet communicating with the receiving cavity, the receiving cavity defining a main flow section and a bypass flow section;

a water pump provided in the receiving cavity of the main body and arranged to pump water from the water inlet to the water outlet through the receiving cavity;

a main filter assembly provided in the main flow section of the receiving cavity; and

a bypass filtration flow system, which comprises:

a bypass filtering channel formed in the receiving cavity at a position out of the main flow section and retaining fluid communication with the main flow section;

a bypass filter assembly provided at the bypass filtering channel; and

a control valve provided in the receiving cavity to selectively operate between a first position and second position, wherein:

when the control valve is in the first position, the control valve blocks the bypass filtering channel so that water flowing into the receiving cavity is directed through the main flow section through the main filter assembly and exits the receiving cavity through the water outlet; and

when the control valve is in the second position, the control valve opens the bypass filtering channel so that water flowing into the receiving cavity through the water inlet is directed through at least one of the main flow section and the bypass filtering channel through the main filter assembly and the bypass filter assembly respectively, and exits the receiving cavity through the water outlet.

This summary presented above is provided merely to introduce certain concepts and not to identify any key or essential features of the claimed subject matter.

### BRIEF DESCRIPTION OF THE DRAWINGS

FIG. 1 a schematic diagram of a pool cleaning robot according to an embodiment of the present invention, illustrating a control valve is closed.

FIG. 2 another schematic diagram of the pool cleaning robot according to an embodiment of the present invention, illustrating the control valve is closed and a main filter assembly is substantially blocked by pool debris.

FIG. 3 another schematic diagram of the pool cleaning robot according to an embodiment of the present invention, illustrating the control valve is opened.

FIG. 4 is a block diagram illustrating electrical connections between various components of the pool cleaning robot according to an embodiment of the present invention.

FIG. 5 is a schematic diagram of the pool cleaning robot according to an embodiment of the present invention, illustrating that a control valve is closed.

FIG. 6 is a schematic diagram of the pool cleaning robot according to an embodiment of the present invention, illustrating that a control valve is opened.

FIG. 7 is a schematic diagram illustrating an alternative configuration of a bypass filtering channel of the pool cleaning robot according to an embodiment of the present invention.

FIG. 8 is a perspective schematic diagram of FIG. 7.

FIG. 9 is a schematic diagram illustrating another alternative configuration of bypass filtering channels of the pool cleaning robot according to an embodiment of the present invention.

FIG. 10 is a perspective schematic diagram of FIG. 9.

FIG. 11 is a schematic diagram illustrating another alternative configuration of a bypass filtering channels of the pool cleaning robot according to an embodiment of the present invention.

FIG. 12 is a perspective schematic diagram of FIG. 11.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

It should be appreciated that the terms "length", "width", "top", "bottom", "front", "rear", "left", "right", vertical", "horizontal", "upper", "lower", "exterior", and "interior" in the following description refer to the orientation or positioning relationship in the accompanying drawings for easy understanding of the present invention without limiting the actual location or orientation of the present invention. Therefore, the above terms should not be an actual location limitation of the elements of the present invention.

It should be appreciated that the terms "first", "second", "one", "a", and "an" in the following description refer to "at least one" or "one or more" in the embodiment. In particular, the term "a" in one embodiment may refer to "one" while in another embodiment may refer to "more than one". Therefore, the above terms should not be an actual numerical limitation of the elements of the present invention.

It should be appreciated that the terms "install", "connect", "couple", and "mount" in the following description refer to the connecting relationship in the accompanying drawings for easy understanding of the present invention. For example, the connection can refer to permanent connection or detachable connection. Therefore, the above terms should not be an actual connection limitation of the elements of the present invention.

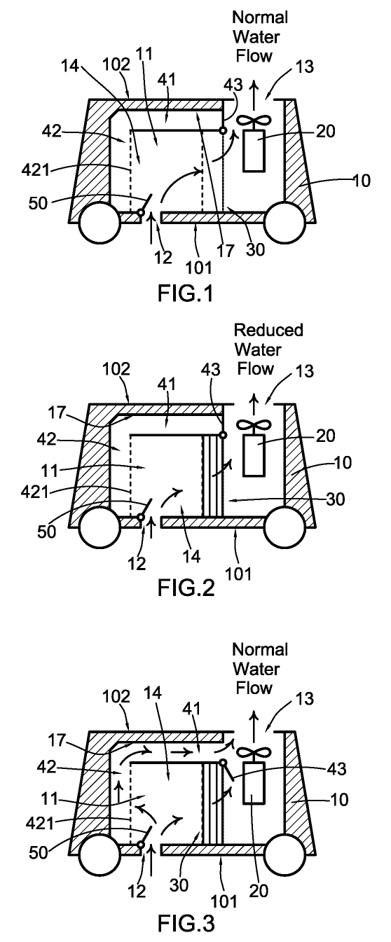

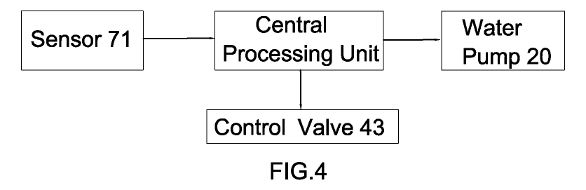

Referring to FIGS. 1 to 6 of the drawings, a pool cleaning robot according to one embodiment of the present invention is illustrated. Broadly, the pool cleaning robot may comprise a main body 10, a water pump 20, a main filter assembly 30, and a bypass filtration flow system 40. The pool cleaning robot of the present invention is for cleaning pool debris of a pool containing pool water.

The main body 10 may have a receiving cavity 11, a water inlet 12 and a water outlet 13. The water inlet 12 and the water outlet 13 may communicate with the receiving cavity 11. The receiving cavity 11 may define a main flow section 14.

The water pump 20 may be provided in the receiving cavity 11 of the main body 10, and may be arranged to pump pool water to flow from the water inlet 12 to the water outlet 13 through the receiving cavity 11.

The main filter assembly 30 may be provided in the main flow section 14 of the receiving cavity 11.

The bypass filtration flow system 40 may comprise a bypass filtering channel 41, a bypass filter assembly 42, and a control valve 43. The bypass filtering channel 41 may be formed in the receiving cavity 11 at a position out of the main flow section 14 and retain in fluid communication with the main flow section 14.

The bypass filter assembly 42 may be provided in the receiving cavity 11 and communicate with the bypass flow section 15 of the receiving cavity 11.

The control valve 43 may be provided in the receiving cavity 11 to selectively operate between a first position and a second position, wherein in the first position, the control valve 43 may be moved to block the bypass filtering channel 41 so that the pool water flowing into the receiving cavity 11 may be forced to solely pass through the main flow section 14 through the main filter assembly 30 and exit the receiving cavity 11 through the water outlet 13, wherein in the second position, the control valve 43 may be moved to open the bypass filtering channel 41 so that the pool water flowing into the receiving cavity 11 through the water inlet 12 may be arranged to pass through at least one of the main flow section 14 and the bypass flow section 15 through the main filter assembly 30 and the bypass filter assembly 42 respectively, and eventually exit the receiving cavity 11 through the water outlet 13.

According to the one embodiment of the present invention, the pool cleaning robot may be utilized in a pool for picking up pool debris, such as leaves, ashes, particulates, or other dirt (collectively termed “pool debris” hereinafter). The pool cleaning robot may travel on pool water or along the pool floor. When the pool cleaning robot travels in pool water, pool water may be pumped by the water pump 20 to enter the receiving cavity 11 through the water inlet 12, pass through at least one of the main filter assembly 30 and the bypass filter assembly 42, and exit the receiving cavity 11 through the water outlet 13. Pool debris from the pool water may be trapped by the main filter assembly 30 and/or the bypass filter assembly 42 so that the pool water flowing out of the receiving cavity 11 of the main body 10 is substantially free from pool debris.

The main body 10 may be configured from durable and light material such as plastic material so that it can conveniently travel through pool water. The water inlet 12 and the water outlet 13 may be formed on two opposing sides of the main body 10. For example, the water inlet 12 may be formed on a bottom side 101 of the main body 10, and the water outlet 13 may be formed on a top side 102 of the main body 10.

The receiving cavity 11 may be formed between the water inlet 12 and the water outlet 13, and may define a main flow section 14. The main flow section 14 is where the main filter assembly 30 is located. In normal circumstances, pool water may be arranged to flow into the receiving cavity 11 through the water inlet 12, arranged to pass through the main filter assembly 30, and discharged out of the receiving cavity 11 through the water outlet 13. Pool debris may be substantially trapped by the main filter assembly 30. In this situation, the control valve 43 may be closed and in the first position, as shown in FIG. 1 of the drawings.

The main flow section 14 and the bypass filtering channel 41 may be separated by at least one partitioning wall 16, at least one bypass filter assembly 42, or a combination of both. Thus, the main body 10 may further comprise at least one partitioning wall 16 provided in the receiving cavity 11 to define and divide the receiving cavity 11 into the main flow section 14 and the bypass filtering channel 41. Pool water flowing through the water inlet 12 may either be directed to flow through at least one of the main flow section 14 and the bypass filtering channel 41. In the situation where the control valve 43 is in the first position, the pool water flowing through the water inlet 12 may be directed to solely pass through the main flow section 14 of the receiving cavity 11. In this situation, pool water flowing out of the water outlet 13 may be within a predetermined or designed flow rate.

In this situation, since the control valve 43 is in the first position, the bypass filtering channel 41 may be blocked and pool water may not be able to flow through the bypass filtering channel 41 and reach the water outlet 13. Thus, all pool water coming from the water inlet 12 may be directed to pass through the main filter assembly 30.

The water pump 20 may be mounted in the receiving cavity 11 for generating circulation of water in the receiving cavity 11. Preferably, the water pump 20 may be positioned in the main flow section 14 of the receiving cavity 11. As shown in FIG. 1 of the drawings, the water pump 20 may be positioned proximate to the water outlet 13. However, it is worth mentioning that the water pump 20 may be positioned anywhere in the receiving cavity 11 as long as it may generate adequate water circulation in the receiving cavity 11.

The main filter assembly 30 may be positioned in the main flow section 14 of the receiving cavity 11 for stopping passage of pool debris. The main filter assembly 30 may comprise at least one main filter screen 31 mounted in the main flow section 14 of the receiving cavity 11, wherein the main filter screen 31 may be configured as having a mesh structure and have a plurality of passage holes. The size of the passage holes may determine the effectiveness of trapping pool debris. For example, the passage holes may be shaped and sized to trap debris of larger size such as leaves, stems, or other dirt which may appear in the pool water.

As shown in FIG. 1 to FIG. 3 of the drawings, the main filter assembly 30 may comprise a plurality of main filter screens 31 in which the size of the passage holes of different main filter assembly screens may be different. For example, two main filter screens 31 may be mounted in the receiving cavity 11 in which the passage holes of one of the filter screens may be larger than that of the other, so that one of the main filter screens 31 may trap debris of larger size, while another of the main filter screens 31 may trap debris of smaller size. Thus, the two main filter screens 31 may be configured as a coarse mesh screen and a fine mesh screen respectively. As debris of large and small sizes enter the receiving cavity 11 through the water inlet 12, debris of larger size may be intercepted by the coarse mesh screen, whereas debris of smaller sizes may pass through the coarse mesh screen and proceed to the second main filter assembly screen 31, where they are subsequently captured by the fine mesh screen. The main filter assembly 30 may comprise several main filter screens 31 connected together to form a specific structure (such as a rectangular structure) in the receiving cavity 11.

The pool cleaning robot may further comprise a one-way valve 50 mounted on the main body 10 at a position proximate to the water inlet 12 for selectively preventing the pool water in the receiving cavity 11 from exiting the receiving cavity 11 through the water inlet 12 (i.e. backflowing from the receiving cavity 11). In a typical operation cycle of the pool cleaning robot, when the water pump 30 operates, the one-way valve 50 may be set to open so as to allow pool water to flow from the water inlet 12 to the main flow section 14 of the receiving cavity 11. When the water pump 30 stops, the one-way valve 50 may be arranged to close, thus preventing trapped debris and particulates from flowing back into the pool through the water inlet 12.

It is worth mentioning that the fine mesh filters are more prone to clogging, which may result in a reduction in water flow within the receiving cavity 11. A decrease in water flow can negatively impact the cleaning efficiency and operational performance of the pool cleaning robot. As a result, the bypass filtration flow system 30 is designed to tackle this situation. When the main filter assembly 30 is unobstructed, the control valve 43 remains at the first position. However, when the main filter assembly 30 is substantially blocked, reduced water flow may occur at the water outlet, as shown in FIG. 2 of the drawings. At this time, the control valve 43 may be arranged to open and switch to the second position so as to allow pool water to flow through the bypass filter assembly 42.

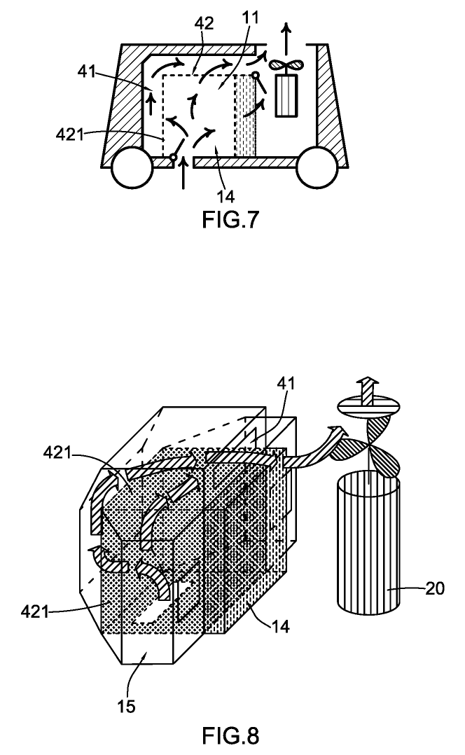

The main filter assembly 30 may be mounted in the main flow section 14 for regular filtering cleaning routine. The main flow section 14 and the bypass filtering channel 41 may be provided in a side-by-side or a top-down manner, as exemplified in FIGS. 7 to 10 of the drawings (described in more details below). As shown in FIG. 1 of the drawings, in one embodiment of the present invention, the pool water entering the receiving cavity 11 through the water inlet 12 may be directed to enter the main flow section 14 and the bypass filtering channel 41.

The bypass filter assembly 42 may comprise at least one bypass filter screen 421 mounted in the receiving cavity 11 and may be mounted at the bypass filtering channel 41. Note that the bypass filter assembly 42 may be mounted inside the bypass filtering channel 41 of the receiving cavity 11 or at the intersection between the main flow section 14 and the bypass filtering channel 41. In the latter situation, the bypass filter screen 421 may separate the bypass filtering channel 41 from the main flow section 14 so that the bypass filtering channel 41 may be positioned out of the main flow section 14 but still in fluid communication with the main flow section 14. The bypass filter assembly 42 may also be in fluid communication with the main flow section 14 of the receiving cavity 11.

Referring to FIG. 2 of the drawings, the bypass filter screen 421 may be provided at the intersection between the main flow section 14 and the bypass filtering channel 41. Thus, the bypass filtering channel 41 may be formed by the space, within the receiving cavity 11, surrounded by the bypass filter screen 421, the partitioning wall 16, and a sidewall 17 of the main body 10.

The control valve 43 may be formed in the bypass filtering channel 41 at a position near the water outlet 13. The control valve 43 may be configured as an active valve, which is actuated by a driving mechanism, such as a motor-operated valve or a solenoid valve. The driving mechanism may be controlled by a central processing unit 70 of the pool cleaning robot.

Thus, when the main filter assembly 30 is substantially blocked, the blockage condition may be detected through methods such as monitoring the motor load of the water pump 20, utilizing one or more pressure sensors, or employing one or more flow sensors. The central processing unit 70 then determines the degree of blockage and controls the driving mechanism to switch the control valve 43 from the first position to the second position.

Thus, the pool cleaning robot may further comprise a central processing unit 70 and at least one sensor 71 mounted in the receiving cavity 11. The central processing unit 70 may be electrically connected to the water pump 20, the sensor 71, and the control valve 43 so that when the sensor 71 detects a predetermined physical condition (such as a reduced or increased flow rate of pool water), the central processing unit 70 may be arranged to drive the control valve 43 to switch between the first position and the second position. The central processing unit 70 may comprise at least one microprocessor for controlling the operation of the various electrical components of the pool cleaning robot.

Alternatively, the control valve 43 may be configured as a passive valve, which operates based on mechanical principles of hydrodynamics and natural forces, including but not limited to pressure differentials, buoyancy, gravity, elasticity, and magnetism.

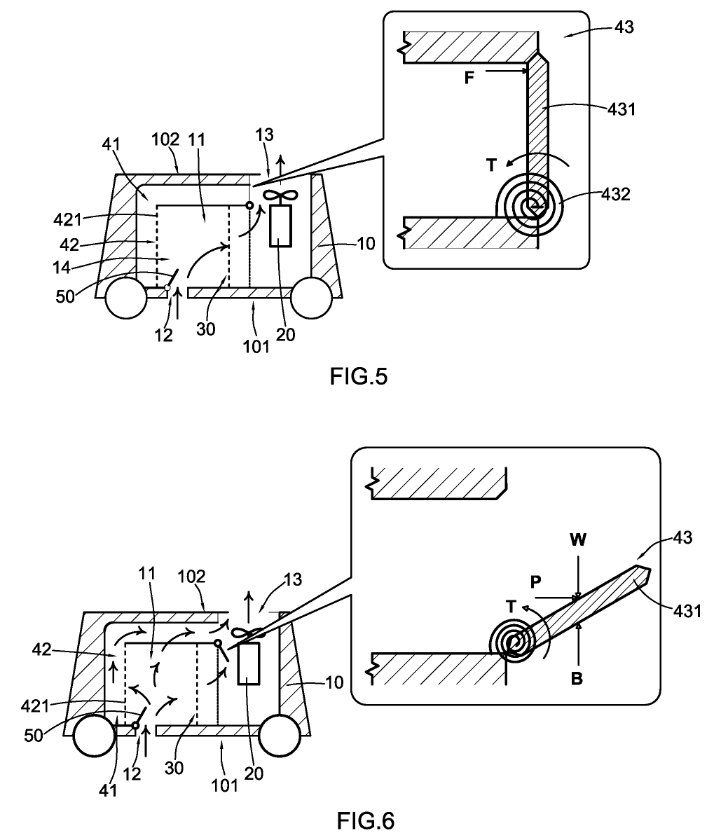

An exemplary embodiment of the control valve 43 being a passive control valve is that the control valve 43 may be configured as having preloaded spring. Referring to FIGS. 5 to 6 of the drawings, the control valve 43 may comprise a valve latch 431 and a resilient element 432 connected to the valve latch 431. The resilient element 432 may be arranged to exert an urging force to the valve latch 431 so as to ensure closure of the bypass filtering channel 41 under normal operating conditions (i.e. when the control valve 43 is in the first position). When the main filter assembly 30 is unobstructed, the pressure distribution between the water inlet 12 and the water outlet 13 remains balanced, keeping the control valve 43 in the first position. When blockage occurs in the main filter assembly 30, a pressure differential is created between the water inlet 12 and the water outlet 13, with the pressure at the water inlet 12 exceeding the pressure at the water outlet 13. Upon reaching a predefined threshold, this pressure differential overcomes the spring force exerted by the resilient element 432, causing the control valve 43 to transit to a second position, so as to allow pool water to enter the bypass filtration channel 41. Once the blockage of the main filter assembly 30 is cleared, the pressure differential may return to the original state and the control valve 43 may return back to the first position. Note that the activation pressure threshold of the control valve 43 may be selectively adjusted by modifying the tension of the resilient element 432. Additionally, by incorporating various force interaction, including elasticity, gravity, buoyancy, and magnetism, the opening and closing behavior of the control valve 43 can be precisely controlled, thereby optimizing the operational efficiency of the bypass filtration flow system 40. The resilient element 432 may be configured as a coil spring.

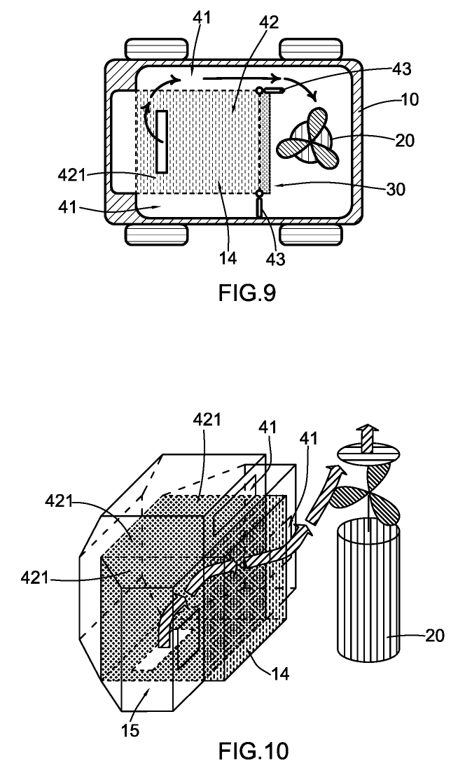

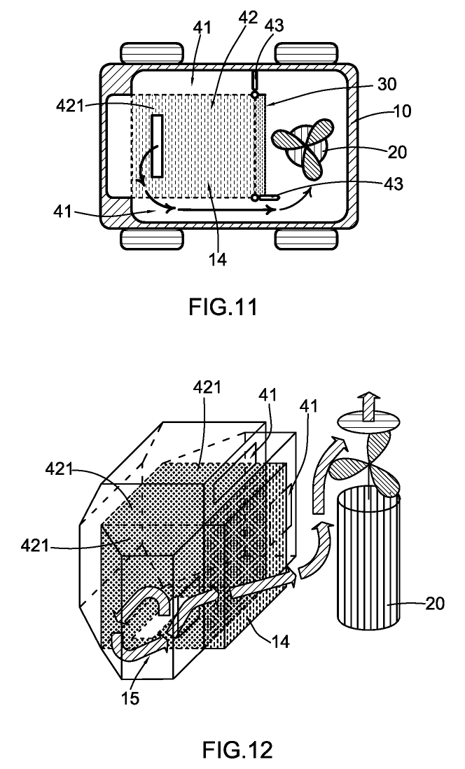

Referring to FIGS. 7 to 12 of the drawings, the bypass filtration flow system 40 may comprise several bypass filtering channels 41 and several control valves 43 provided in the receiving cavity 11 for providing several bypass filtration functions. For example, as shown in FIGS. 7 to 8 of the drawings, the bypass filtering channels 41 may be separated from the main flow section 14 by one or more bypass filters 42. The bypass filtering channel 41 may be provided on top of the main flow section 14. This configuration is also schematically illustrated in FIGS. 9 and 12 of the drawings.

Referring to FIGS. 9 to12 of the drawings, in one embodiment of the present invention, the receiving cavity 11 may have one main flow section 14 and three bypass filtering channels 41 provided on two sides and on top of the main flow section 14 respectively.

Accordingly, the bypass filtration flow system 40 may comprise a plurality of bypass filtering channels 41 provided in the receiving cavity 11 of the main body 10, a plurality of bypass filters assemblies 42 and a plurality of control valves 43 provided in the bypass filtering channels 41 respectively. Each of the control valves 43 may be independently operated and centrally controlled by the central processing unit 70. Each of the control valves 43 may therefore be arranged to operate between the first position and the second position. Thus, each of the bypass filtering channels 41 may be selectively arranged to allow pool water to flow thereto. For example, each of the bypass filtering channels 41 may be sequentially opened by the relevant control valve 43 to tackle blockage problems. When the main filter assembly 30 is substantially blocked, one of the control valves 43 may be switched to the first position so as to unblock the relevant bypass filtering channel 41. As such, the pool water may be allowed to flow through that bypass filtering channel 41 and reach the water outlet 13. Debris may be trapped by the relevant bypass filter assembly 42. If this particular bypass filter assembly 42 is also blocked, another control valve 43 may be switched to the second position so as to unblock another bypass filtering channel 41. Pool water may then be directed to flow through another bypass filtering channel 41. These mechanisms may continue for other bypass filtering channels 41.

Alternatively, when the main filter assembly 30 is substantially blocked, all control valves 43 may be switched to the second position so as to unblock the all bypass filtering channels 41. The exact sequence and conditions by which the control valves 43 are switched may depend on several design and manufacturing circumstances of the present invention.

By employing the bypass filtration flow system, the efficiency and operational lifespan of the main filter assembly 30 may be substantially enhanced. In conventional single-flow filtration pathways such as those described in the Background section above, pool debris and particulates tend to accumulate in the filtering screen region adjacent to the water pump 20, leading to localized clogging and reducing overall filtration efficiency. However, by selectively actuating the control valves 43 of the bypass filtration flow system 40, the pool water flow can be dynamically redirected through different filtering screen regions, thereby optimizing filtration distribution, mitigating clogging effects, and improving the cleaning efficiency of the pool cleaning robot of the present invention.

The present invention, while illustrated and described in terms of the embodiments and several alternatives, is not limited to the particular description contained in this specification. Additional alternative or equivalent components could also be used to practice the present invention.

What is claimed is:

1. A pool cleaning robot, comprising:
a main body having a receiving cavity, a water inlet, and a water outlet, the water inlet and the water outlet communicating with the receiving cavity, the receiving cavity defining a main flow section and a bypass flow section;
a water pump provided in the receiving cavity of the main body and arranged to pump water from the water inlet to the water outlet through the receiving cavity;
a main filter assembly provided in the main flow section of the receiving cavity; and
a bypass filtration flow system, which comprises:
a bypass filtering channel formed in the receiving cavity at a position out of the main flow section and retaining fluid communication with the main flow section;
a bypass filter assembly provided at the bypass filtering channel; and
a control valve provided in the receiving cavity to selectively operate between a first position and second position, wherein:
when the control valve is in the first position, the control valve blocks the bypass filtering channel so that water flowing into the receiving cavity is directed through the main flow section through the main filter assembly and exits the receiving cavity through the water outlet; and
when the control valve is in the second position, the control valve opens the bypass filtering channel so that water flowing into the receiving cavity through the water inlet is directed through at least one of the main flow section and the bypass filtering channel through the main filter assembly and the bypass filter assembly respectively, and exits the receiving cavity through the water outlet.

2. The pool cleaning robot, as recited in claim 1, wherein the main body further comprises at least one partitioning wall to separate the bypass filtering channel and the main flow section of the receiving cavity.

3. The pool cleaning robot, as recited in claim 2, wherein the bypass filter assembly is positioned in the receiving cavity to separate the bypass filtering channel and the main flow section of the receiving cavity.

4. The pool cleaning robot, as recited in claim 3, wherein the bypass filter assembly comprises at least one bypass filter screen mounted in the receiving cavity of the main body and at the bypass filtering channel.

5. The pool cleaning robot, as recited in claim 3, wherein the bypass filter screen is positioned at an intersection between the main flow section and the bypass filtering channel.

6. The pool cleaning robot, as recited in claim 1, further comprising a one-way valve mounted on the main body at a position proximate to the water inlet and configured to selectively prevent backflow of the water in the receiving cavity when the water pump is deactivated.

7. The pool cleaning robot, as recited in claim 4, further comprising a one-way valve mounted on the main body at a position proximate to the water inlet and configured to selectively prevent backflow of the water in the receiving cavity when the water pump is deactivated.

8. The pool cleaning robot, as recited in claim 5, further comprising a one-way valve mounted on the main body at a position proximate to the water inlet and configured to selectively prevent backflow of the water in the receiving cavity when the water pump is deactivated.

9. The pool cleaning robot, as recited in claim 1, further comprising a central processing unit and at least one sensor mounted in the receiving cavity, wherein the control valve, the at least one sensor, and the water pump are electrically connected to the central processing unit so that when the sensor detects a predetermined physical condition, the central processing unit is configured to cause the control valve to switch between the first position and the second position.

10. The pool cleaning robot, as recited in claim 5, further comprising a central processing unit and at least one sensor mounted in the receiving cavity, wherein the control valve, the at least one sensor, and the water pump are electrically connected to the central processing unit so that when the sensor detects a predetermined physical condition, the central processing unit is configured to cause the control valve to switch between the first position and the second position.

11. The pool cleaning robot, as recited in claim 8, further comprising a central processing unit and at least one sensor mounted in the receiving cavity, wherein the control valve, the at least one sensor, and the water pump are electrically connected to the central processing unit so that when the sensor detects a predetermined physical condition, the central processing unit is configured to cause the control valve to switch between the first position and the second position.

12. The pool cleaning robot, as recited in claim 1, wherein the control valve comprises a valve latch and a resilient element connected to the valve latch and configured to exert a biasing force against the valve latch.

13. The pool cleaning robot, as recited in claim 5, wherein the control valve comprises a valve latch and a resilient element connected to the valve latch and configured to exert a biasing force against the valve latch.

14. The pool cleaning robot, as recited in claim 8, wherein the control valve comprises a valve latch and a resilient element connected to the valve latch and configured to exert a biasing force against the valve latch.
